(19) United States
(12) Patent Application Publication
(10) Pub. No.: US 2011/0197628 A1
(43) Pub. Date: Aug. 18, 2011

(54) CRYOAGGREGATE FILTRATION FOR THE TREATMENT OF CARDIOMYOPATHY AND OTHER AUTOIMMUNE DISEASES

(75) Inventors: Yukihiko Nose, Houston, TX (US); Toshiya Okahisa, Tokushima (JP); Hiroshi Miyamoto, Houston, TX (US); Tadashi Motomura, Houston, TX (US)

(73) Assignee: Baylor College of Medicine, Houston, TX (US)

(21) Appl. No.: 12/864,290

(22) PCT Filed: Jan. 26, 2009
(86) PCT No.: PCT/US09/32063

§ 371 Date: Mar. 23, 2011

Related U.S. Application Data
(60) Provisional application No. 61/023,800, filed on Jan. 25, 2008.

(51) Int. Cl. B01D 9/02

(52) U.S. Cl. 62/532; 62/123

(57) ABSTRACT

Various embodiments of the present invention disclose processes and systems for the off-line in-vitro purification of plasma harvested from a patient. In an embodiment of a process, in a first step cellular components are capable of being eliminated by membrane plasma separation at temperatures sufficiently high to avoid formation of a cryoaggregates, and in a second step the resulting plasma solution is cooled to a temperature that allows the formation of cryoaggragated molecules, but no formation of a cryogel.

### RELATED APPLICATIONS

This application claims priority to International Application No. PCT/US2009/032063, filed on Jan. 26, 2009, which claims priority to U.S. Provisional Application No. 61/023,800, filed on Jan. 25, 2008.

### FIELD OF THE INVENTION

Various embodiments of the present invention generally relate to systems and methods for plasmapheresis. In specific embodiments, the plasmapheresis is a combination therapy of plasma separation and cryoaggregate separation (removal).

### BACKGROUND OF THE INVENTION

A cyrofiltration therapy for plasma purification has been developed and is widely used for the treatment of auto-immune diseases including rheumatoid arthritis. For this therapy, a patient's plasma is separated from the heparinized blood using a membrane plasma separator and is cooled to near 0.0 centigrade. A substance called Cryogel, an example of which is depicted in FIG. 1, which contains a number of pathologic molecules, is filtered from the cold plasma at near zero degrees (0-4° C.) using a cryofilter having a pore structure of 0.1-0.5 μm.

### SUMMARY OF THE INVENTION

### Cryoaggregate Filtration

In some patients which suffer from autoimmune diseases and metabolic diseases, there are diseases causing unwanted macro-minimolecules in existence in patient's plasma. Replacing this diseased plasma with albumin-saline replacement fluids should have therapeutic benefits. Technologies to separate plasma by centrifugal methods from the cellular components of the blood were well developed during the 1960's. The membrane plasma separator (with pore structure of 0.1-0.5 μm) was introduced in 1977. Information on historical developments and current status of therapeutic apheresis are available in various publications.^{1,2,3}

The plasma exchanges technologies by centrifugal and membrane plasma separation were well established and routinely performed during the last thirty years in various parts of the world. For the typical plasma exchange, one plasma volume of the patient was removed from the patient while replacing it with the albumin-saline solution. For adult patients, approximately three liters of patient's plasma are removed and replaced with two liters of albumin solution (5%) and possibly one liter γ-globulin solution (500 mg/kg). The procedure is typically applied on a patient approximately every other day for 5-7 days to produce a therapeutic effect. However, the frequency of treatments can vary from patient to patient.

This procedure has been widely used in the world. However, the majority of plasma exchange procedures in the US are performed by the centrifugal method. In Europe, half of the procedures are centrifugal method, while the other half are by membrane methods. In Japan, almost all of the procedures are membrane methods.

Membrane plasma exchange methods are not only expensive, but also clinically unsafe by certain standards because there is a high potential for contaminated replacement fluids. In various regions, instead of conventional replacement fluids, purified autologous plasma has been utilized by removing the disease causing macro-mini molecules from the plasma online rather than discarding the withdrawn plasma. An additional plasma fractionator is added that purifies the separated autologous plasma online. This double membrane filtration method is an accepted method in various regions.

Three types of double filtration plasmapheresis methods have been primarily employed during the last twenty five years. The plasma fractionation is performed at different temperatures depending upon the type of plasmapheresis performed. Cryofiltration is performed at 0-4° C., double filtration plasmapheresis is performed at 37°-30° C., and thermofiltration is performed at 37°-43° C. All of the aforementioned temperature ranges are modified by the term about and it is understood that some variance in the temperatures is permissible. These three methods of the double filtration are known in the art and generally summarized in FIG. 2.

Cryofiltration therapy for plasma purification is known in the art and widely used for the treatment of autoimmune diseases including rheumatoid arthritis. For this therapy, a patient's plasma is separated from the heparinized blood which is extra-corporeally pumped out from the patient at the rate of about 100 ml/min using a membrane plasma separator (pore structure 0.1-0.5 μm) and is cooled to near 0° centigrade. A substance called cryogel, an example of which is depicted in FIG. 2 which contains a number of pathologic molecules, is filtered from the cold plasma at near zero degrees (0-4° C.) using a cryofilter having a pore structure of 0.1-0.5 μm.

Double filtration plasmapheresis is also known in the art. The plasma fractionator (pore structure 0.01-0.05) is used for separating plasma without any temperature control. Thus the temperatures of the plasma going through the plasma fractionator are in the range of 30° C.-37° C., in general. This method of double filtration removes not only all globulin fractions, but also some portion of albumin solution. Thus it is required to have albumin solution infusion to make up the lost albumin from this procedure.

Plasma fractionation performed by thermofiltration is also known in the art. This method of plasma purification specifically aimed to remove LDL-cholesterol. Thus, the method is therapeutically effective for the treatment of hyperlipidermic patients. Loss of albumin was lower compared with the double filtration plasmapheresis.

Recently, our group has found that molecules in plasma become larger when heparinized plasma is exposed to low temperatures. When plasma is cooled below 30° C., the majority of molecules in the plasma are between about 0.01-0.1 μm in size. Under these circumstances, plasma is removed from the patient using a membrane plasma separator (0.1-0.5 μm) and cryoaggregate can be filtered from the plasma using a membrane plasma fractionator having a pore size of about 0.01-0.1 μm at a temperature below 30° C. If this process can be done off-line (in-vitro), the patients' harvested plasma can be purified to remove pathologic molecules and be re-infused as a safe and inexpensive replacement fluid for plasma exchange.

Compared to the conventional albumin-saline replacement fluids for plasma exchange, autologous plasma purification with removal of cryoaggregate factors should be physiologically acceptable and clinically safe and effective. Cryoaggregate filtered purified plasma contains sufficient levels of albumin and γ-globulin fraction, therefore eliminating the need for expensive substitution fluids or supplemental macro-molecules and making the plasma exchange procedure more cost effective.

When the plasma is cooled below 30° C., the clear yellowish colored plasma becomes the white milky appearance (FIG. 3). The molecular sizes of an aggregate of molecules in the plasma becomes larger by cryoaggregation (FIG. 4). The plasma fractionator effectively removes aggregated molecules from the plasma because molecules in the plasma become larger, the plasma fractionator with larger pore size membrane should be able to remove not only pathological macromolecules, but also pathological minimolecules.

Double filtration performed at the temperature between 30° C. to 4° C. is not used in the art as it was considered not effective due to cryogel formation at lower temperatures, among other reasons.

An embodiment of the present invention is referred to as cryoaggregate filtration or PATCAT (Pressure and Temperature Controlled Apheresis Therapy) system. For the plasma separation, it is known that the effective membrane plasma separation should be performed when the transmembrane pressures should be near zero mm Hg (In an embodiment, preferably less than 50 mm Hg). However, it is unexpected that blood temperature for plasma separation should be performed at above 30° C. The higher temperature for plasma separation inhibits a significant amount of cryoaggregate formation. Cryoaggregate formation may include some pathological macromolecules being separated with the separated plasma. Thus, therapeutic effects of double filtration would not be achieved.

However for the plasma fractionation of the harvested plasma, the temperature should be between 30° C.-4° C. If it is higher than 30° C., no cryoaggregation takes place in the plasma, while if it is below 4° C. the cryogel formation occurs and effective enlargement of macromolecular size will be eliminated. Typically, in various embodiments, the plasma fractionator fails with its transmembrane pressure more than 500 mm Hg. It was shown that when a plasma fractionator removed macromolecules more than its capacity, the transmembrane pressure suddenly increased more than 300 mm Hg resulting in potential leakage of the harvested/separated cryoaggregates. Accordingly, in various embodiments, plasma fractionation should be performed with temperature ranges for the plasma of about 30° C.- about 4° C. and the transmembranes pressures between about zero to about 300 mm Hg However, various embodiments will function with higher pressures. Thus, in various embodiments, a proper temperature and pressure for each filtration procedures should be maintained.

In various embodiments, when membrane plasma separation takes place, at the transmembrane pressure of the plasma separator below about 100 mm Hg and at about 30° C. or above, the separated plasma is a clean plasma containing substantially all pathological molecules. Further, it does not contain any substantial amount of platelets or any white cell fractions or destructed components of red cells. When the plasma separation is performed at higher transmembrane pressures, the pore structures of the plasma separator membrane will be clogged by blood cells and subsequent destruction of red cells takes place. This phenomenon not only stops effective plasma separation but also introduces hemolysis and the loss of red cells in the blood. In an embodiment, plasma separation performed at a transmembrane pressure near zero and at 30°-37° generated the clean whole plasma without any substantial contamination, other than the potential pathological molecules. In general the plasma separated by membrane can be subjected to immediate plasma fractionation. Primarily the PATCAT system is applicable as both an online procedure and an off-line procedure.

In an on-line system a cryoaggregate filtration circuit or system can be connected directly to a membrane plasma exchange system. In such a system, the separated plasma from the plasma separation membrane would be cooled to a temperature between about 4-30° C. and fed to a cryoaggregate plasma fractionation filter whereby a cryoaggregate is formed containing at least a substantial portion of the pathological molecules, thus producing clean plasma. Accordingly, it is not necessary to discard the harvested plasma. Embodiments of this process would function not only with membrane apheresis, but also with centrifugal apheresis. However, because plasma harvested by the centrifugal method is not generally clean, a filtering of the harvested plasma is advisable such that any subjects larger than 0.1 μm in diameter are removed prior to cryoaggregate filtration. After filtering, a cryoaggregate filtration step can be performed to produce purified plasma.

Various embodiments further comprise an off-line system. In such a system, the separated plasma from the plasma separation step is collected in a container, such as a bag, and the container is taken off-line to the cryoaggregate filtration step whereby the plasma solution is cooled to a temperature between about 4-30° C. and fed to a cryoaggregate plasma fractionation filter whereby a cryoaggregate is formed containing at least a substantial portion of the pathological molecules, thus producing clean plasma as a final product. In various embodiments, this system is designated as the Offline Automatic Plasma Purifier for Exchange Transfusion system or the Off-LAPPET system.

### Apheresis for Autoimmune and Metabolic Diseases

Cryoaggregate filtration of a patient's plasma is one of the apheresis procedures to remove pathogenic and health disorder producing macro-mini molecules from the plasma of autoimmune and metabolic disorder patients. It is also possible to remove circulating viruses and/or pathogenic agents. There are other diseases that are also treated with apheresis.

Among these diseases are the collagen diseases including systemic lupus erthemotosus (SLE) and malignant rheumatoid arthritis (MRA). Many diseases, including myasthenia gravis, Lambert-Eaton syndrome, Guillain-Barre syndrome and others are also treated by apheresis.

In autoimmune conditions, the body's immune system mistakenly turns against itself, attacking its own tissues. Some of the specialized cells involved in this process can attack tissues directly, while others can produce substances known as antibodies that circulate in the blood and carry out the attack. Antibodies against the body's own tissues are known as autoantibodies. Apheresis is also provided for many metabolic diseases including liver insufficiency, familiar hypercholesteromia, and renal insufficiency.

### Cryoaggregate Filtration as a Therapeutic Tool for Cardiomyopathic Diseases

Non-ischemic cardiomyopathy is an autoimmune disease. Successful apheresis procedures with immunoadsorption columns have been reported for the treatment of non-ischemic cardiomyopathy patients. Typically, IgG removal columns (Ig-Therasorb, Plasmaselect Teterow, Germany) or Protein-A columns (Immuno-sorba, Freserius, St Wendel Germany) have been applied.

Immunoadsorption therapy using an IgG removal column for non-ischemic cardiomyopathy patients was initiated by the group in Berlin, Germany. They treated 17 patients (control=17 patients) during five (5) immunoadsorption therapy sessions with follow-up for one year. They demonstrated improved cardiac function and clinical status of the patients.

A protein-A immunoadsorption affinity column has been used by both the German group and the group from the Mayo Clinic. Based upon initial clinical studies by Drs. Stephen Felix (Greifswald, Germany) and Leslie Cooper (Mayo Clinic), these investigators concluded that the IgG3 removal rate is closely related to clinical outcomes and must be 65% from baseline to final values at the end of 5 daily treatment sessions.

Felix and Cooper demonstrated that use of the Immunosorba Anti-IgG3 column over five (5) consecutive treatment days resulted in improved clinical outcomes with significant improvement in left ventricular ejection fraction at a 3 and 6-months follow-up.

Removal of autoantibody from non-ischemic cardiomyopathic patients by the Berlin group demonstrated cardiac functional recovery after five sessions of treatments in five days. This myocardial recovery maintained as long as five years. Patient survivals of apheresed patients were approximately 80% for five years. While non apheresis patients with drug therapies were approximately 40%. Total costs involved for these therapies were much lower in the apheresis group.

Recently, plasma exchange pilot studies were performed by Dr. Guillermo Torre of BCM (Baylor College of Medicine) on non-ischemic cardiomyopathic patients. So far, 8 out of 9 patients improved their cardiac functions after 5 sessions of 31 plasma exchanges. One patient passed away due to heart failure during study periods. These effects were revealed in 6 weeks and endured for 12 months (unpublished data).

For ischemic cardiomyopathy, it is generally accepted that three biochemical abnormalities cause atherosclerotic regions. They are low density lipoprotein, causing lipid producing atherosclerosis, fibrinogen, causing microclot produced atherosclerosis, and antibodies, causing calcium deposited atherosclerosis.

Removal of fibrinogen, LDL-cholesterol has been attempted by apheresis. The removal of the macromolecules improved the rheological nature of the blood, resulting in elimination of chest pain and less frequent visits to the doctor's office.

In an embodiment, the Off-LAPPET system removed selectively IgG₃ 40%, cholesterol 35%, Fibrinogen 58% with one session of the treatment. Effective removal of cytokines was also revealed. It is expected that the cryoaggregate filtration should be an effective therapeutic tool for all cardiomyopathic patients.

The following list of publications predict effective outcomes of removing the above mentioned molecules by Off-LAPPET system. For the treatment of cardiomyopathic patients, the following data has been generated by immune-adsorption columns, not cryoaggregate filtration. Muller J and his group was the first to report the effectiveness of immunoadsorption on non-ischemic cardiomyopathy⁴, Felix SB's group^{5,6,7} and Cooper's group^{8,9} demonstrated the need of IgG₃ removal on these patients. Muller's group updated their group's results¹⁰. Immunoadsorption on ischemic cardiomyopathy patients were referred in other papers^{11,12}

Some aspects of the invention relate to an extracorporeal pathogen reduction system comprising means for withdrawing blood from a patient, means for separating a plasma constituent from the blood, means for inactivating pathogen in the plasma constituent, and means for returning treated plasma constituent to the patient. In one embodiment, the means for separating a plasma constituent from the blood comprises a blood filtration apparatus characterized by an orbital motion with filter membrane means. In another embodiment, the means for inactivating the pathogen comprises adding at least one photosensitizer into the plasma constituent and providing photosensitized inactivation to the pathogen at an effective amount of radiation.

Some aspects of the invention relate to a method of extracorporeally reducing pathogen burden of a patient comprising: filtering the patient's blood through a blood filtration apparatus configured for separating a plasma constituent from the blood; passing the plasma constituent through pathogen-reduction means for reducing the pathogen burden in the plasma constituent; and returning cellular components of the patient's blood back to the patient. In one embodiment, pathogen reduced plasma is returned to the patient.

In various embodiments, an anticoagulant is added to a patient's blood during the plasmapheresis procedure. In an embodiment, the anticoagulant is added prior to separation of the cellular components from the withdrawn blood stream. In an alternate embodiment, the anticoagulant is added after separation of the cellular components from the blood stream. In an alternate embodiment, anticoagulant is only added to a portion of the blood containing cellular components. In an alternate embodiment, anticoagulant is only added to a portion of the blood containing plasma. In general, in various embodiments utilizing an anticoagulant, an anticoagulant is capable of being added at any point in the plasmapheresis.

### De-Virusing

Hildreth in U.S. Patent Application Publication Nos. 2002/0128227 and 2002/0132791, the entire contents of which are incorporated herein by reference, discloses a method of reducing the risk of transmission of a sexually transmitted pathogen comprising contacting the pathogen or cells susceptible to infection by the pathogen with a beta-cyclodextrin, wherein the pathogen is an enveloped virus selected from a group consisting of an immunodeficiency virus, a T-lymphotrophic virus, a herpesvirus, a measles virus, and an influenza virus. The plasma de-virusing process by beta-cyclodextrin (and/or alpha-cyclodextrin, gamma-cyclodextrin) is carried out in a de-virusing chamber, wherein the beta-cyclodextrin disrupts the enveloped virus, blocks the ability of the pathogen to infect an otherwise susceptible cell.

In one aspect, the present disclosure provides a method of treating virus-infected blood including, but not limited to, HIV infections and AIDS caused by enveloped viruses having a lipid envelope and spikes covered by glycoproteins. Such methods comprise separating the blood supply into substantially uninfected components and substantially infected components, including plasma and white cells, using at least one separation chamber having appropriate separating membrane with orbital motion. The method further comprises de-virusing the lipid-associated virus with a de-virusing agent, followed by recovering the non-virulent plasma for reinfusion purposes. The term “de-virusing” is intended herein to mean eliminating or decontaminating the virulent effects of a virus. The de-virusing is intended to render the virus-infected substance less virulent, not necessarily eliminating the non-virulent virus body.

### Neurological Disorders

In one aspect, the ability to remove antibody and other immunologically active elements from the blood has led to the use of therapeutic plasmapheresis as a therapy for neurological conditions in which autoimmunity is believed to play a role. In some aspect of the present invention, the antibody and other immunologically active elements are removed from the blood by loading an antibody-specific antigen or an agent (or agents) that is specific to the immunologically active elements onto the filtering membrane of the present invention. It is estimated that one-half of the 20,000 to 30,000 TPE (therapeutic plasma exchange) procedures performed annually at present in the United States are done on patients with neurological disorders.

### Autoimmune Diseases

Many diseases, including myasthenia gravis, Lambert-Eaton syndrome, Guillain-Barre syndrome and others, are caused by a so-called autoimmune process. In autoimmune conditions, the body's immune system mistakenly turns against itself, attacking its own tissues. Some of the specialized cells involved in this process can attack tissues directly, while others can produce substances known as antibodies that circulate in the blood and carry out the attack. Antibodies produced against the body's own tissues are known as autoantibodies.

Other Diseases and/or Disease States

Various further embodiments of the present invention are useful for treating any condition treated by an apheresis procedure.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 is an illustration of an example of a cryogel;

FIG. 2 presents data for various purification methods;

FIG. 3 is an illustration of temperature effect on plasma;

FIG. 4 is an illustration of particle size distribution for cooled plasma;

FIG. 5 is an illustration of a pressure and temperature controlled apheresis system for cryoaggregate removal and plasma purification;

FIG. 6 is an illustration data from cardiomyopathy patients undergoing plasma exchange;

FIG. 7 is an illustration data from cardiomyopathy patients at baseline;

FIG. 8 is an illustration of an embodiment of an in-vitro cryoaggregate removal system;

FIG. 9 is an illustration of two embodiments of a plasma separator and a plasma fractionator;

FIG. 10 is a presentation of technical data from proposed embodiments of the present invention;

FIG. 11 is an illustration of percent removal of macromolecules by cryoaggregate filtration;

FIG. 12 is an illustration of a comparison of cryoaggregate filtration with anti-IgG Column and a Protein-A Column;

FIG. 13 is an illustration of data from cryoaggregate filtration of proinflammatory cytokines;

FIG. 14 is an illustration of a proposed plasma exchange system with re-infusion of autologous purified plasma with centrifugal plasmapheresis;

FIG. 15 is an illustration of a proposed plasma exchange procedure wherein the plasma is purified off-line;

FIG. 16 is an illustration of a purification process of harvested plasma from a plasma exchange procedure as disclosed in FIG. 15;

FIG. 17 is an illustration of comparative removal rates of fibrinogen and Ig fractions by the SR-20 filter and a cryofilter, wherein DCM plasma equals SR-20 filter and RA and SLE equal cryofilters; and

FIG. 18 is an illustration of the compliment activation with SR-20 and other filters.

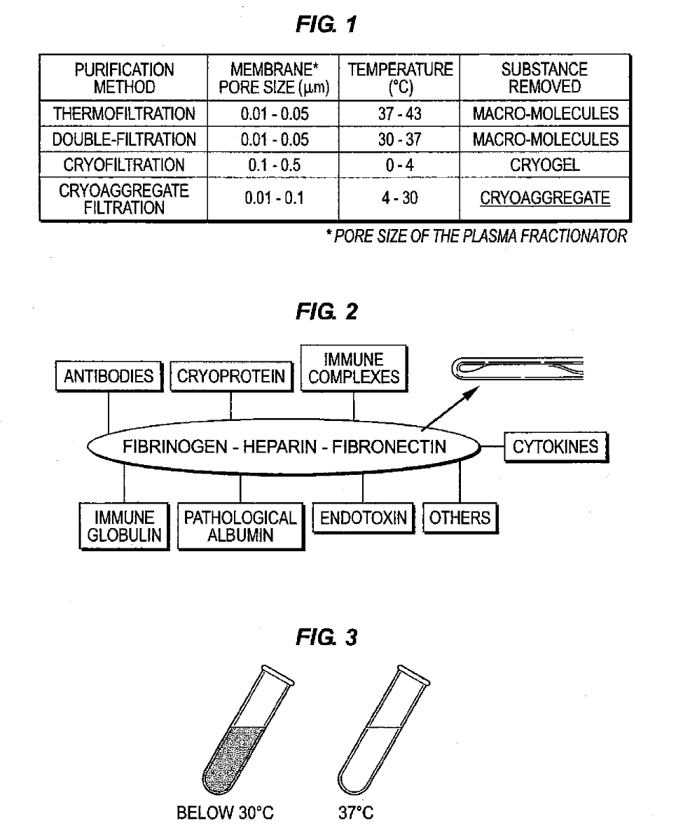

### DETAILED DESCRIPTION OF THE INVENTION

In the following description, specific details are set forth such as specific quantities, sizes, etc. so as to provide a thorough understanding of embodiments of the present invention. However, it will be obvious to those skilled in the art that the present invention may be practiced without such specific details. In many cases, details concerning such considerations and the like have been omitted inasmuch as such details are not necessary to obtain a complete understanding of the present invention and are within the skills of persons of ordinary skill in the relevant art.

The following definitions and explanations are meant and intended to be controlling in any future construction unless clearly and unambiguously modified in the following Examples or when application of the meaning renders any construction meaningless or essentially meaningless. In cases where the construction of the term would render it meaningless or essentially meaningless, the definition should be taken from Webster's Dictionary, 3^{rd} Edition.

The term “biologically active” means capable of effecting a change in a living organism or component thereof. “Biologically active” with respect to “biologically active protein” as referred to herein does not refer to proteins which are part of the microorganisms being inactivated. Similarly, “non-toxic” with respect to the photosensitizers means low or no toxicity to humans and other mammals, and does not mean non-toxic to the microorganisms being inactivated. “Substantial destruction” of biological activity means at least as much destruction as is caused by porphyrin and porphyrin derivatives, metabolites and precursors which are known to have a damaging effect on biologically active proteins and cells of humans and mammals. Similarly, “substantially non-toxic” means less toxic than porphyrin, porphyrin derivatives, metabolites and precursors that are known for blood sterilization.

As used herein, all percentages are percentages by weight, unless stated otherwise.

As used herein, all ranges and numbers are modified by the word about.

A brief discussion of the makeup of blood is shown herein for illustration purposes. Approximately 45% of the volume of blood is in the form of cellular components. These cellular components include red cells, white cells and platelets. If cellular components are not handled correctly, the cells may lose their functionality and become useless. Plasma makes up the remaining 55% of the volume of blood. Basically, plasma is the fluid portion of the blood which suspends the cells and comprises a solution of approximately 90% water, 7% protein and 3% of various other organic and inorganic solutes. As used herein, the term “plasmapheresis” refers to the separation of a portion of the plasma fraction of the blood from the cellular components thereof.

As used herein, the term “therapeutic plasmapheresis” means and refers to a method for removing toxic or unwanted elements, for example, toxins, viral particle, LDL (low density lipoprotein), metabolic substances, and plasma constituents implicated in disease, such as complement or antibodies, from the blood of a patient. The therapeutic plasmapheresis (also referred as “therapeutic plasma exchange”) is performed by removing blood, separating the plasma from the formed elements, and reinfusing the formed elements together with a plasma replacement back to the patient. It is one object of the present invention to provide a method for removing blood from a patient, separating the plasma from the formed elements, filtering the unwanted elements, such as toxins, viral particle, LDL, metabolic substances, and plasma constituents implicated in disease, such as complement or antibodies, and reinfusing the formed elements together with a plasma replacement back to the patient, wherein the filtering step utilizes a blood filtration apparatus characterized by an orbital motion of the present invention.

As used herein, the term “inactivation of a microorganism” means totally or partially preventing the microorganism from replicating, either by killing the microorganism or otherwise interfering with its ability to reproduce.

As used herein, the term “microorganism(s)” means and refers to viruses (both extracellular and intracellular), bacteria, bacteriophages, fungi, blood-transmitted parasites, and protozoa. Exemplary viruses include acquired immunodeficiency (HIV) virus, hepatitis A, B and C viruses, sinbis virus, cytomegalovirus, vesicular stomatitis virus, herpes simplex viruses, e.g. types I and II, human T-lymphotropic retroviruses, HTLV-III, lymphadenopathy virus LAV/IDAV, parvovirus, transfusion-transmitted (TT) virus, Epstein-Barr virus, and others known to the art. Bacteriophages include .PHI.X174, .PHI.6, .lambda., R17, T.sub.4, and T.sub.2. Exemplary bacteria include P. aeruginosa, S. aureus, S. epidermidis, L. monocytogenes, E. coli, K. pneumonia and S. marcescens.

Referring to the drawings in general, it will be understood that the illustrations are for the purpose of describing a particular embodiment of the invention and are not intended to limit the invention thereto.

Filters of the present invention may be any type common in the art. In various embodiments, the filters are comprised of a microfiber medium. In the present invention, a microfiber medium refers to the state where microfibers aggregated, either irregularly or regularly. Such a state can be obtained, for example, by compressing, for example, mass, nonwoven, woven, knitted microfibers independently or in combination. The microfiber medium is preferably nonwoven fabric or mass of microfibers in view of moldability, processability, easiness of handling and difficulty of channeling after packed in a container. In general, any method of construction known in the art can be used.

Various materials can be used for forming the filters. In various embodiments, examples of the material include polyester, polypropylene, polyamide or polyethylene and the like. The material is preferably hydrophobic polypropylene and polyesters (e.g., polyethylene terephthalate). The above-mentioned materials are preferable because when the materials contact blood or plasma components are not adsorbed to the materials, or a part of the materials is not eluted in the plasma. As described in the section of Prior Art, when plasma or serum separation filter of glass fibers is used, electrolytes are eluted from the glass fibers, or phosphorus or lipid is adsorbed to the glass fibers, so that the resultant substances cannot provide accurate measurement results. In general, any material known in the art can be used.

As such, various embodiments of the present invention generally comprise processes for the purification of a first plasma solution taken from a patient, the process comprising the steps of fractionating the first plasma solution to form a second plasma solution, wherein the first plasma solution is at a first temperature sufficiently high to avoid formation of a cryoaggregate; cooling the second plasma solution to a second temperature wherein a cryoaggregate is formed in a third plasma solution, wherein the second plasma solution is at a second temperature sufficiently high to avoid formation of a cryogel; and, filtering the third plasma to removed the cryoaggregate. Further embodiments disclose on-line and off-line systems for the purification of a plasma solution withdrawn from a patient comprising the following components operatively connected to the patient; a pump; a plasma fractionator filter; and a cryoaggregate filter system comprising a cooling unit and a filter. Further embodiments disclose processes for removing pathologic molecules from a first plasma solution, the process comprising the steps of filtering the first plasma solution to form a second plasma solution wherein the first plasma solution is at a first temperature of greater than about 30° C.; cooling the second plasma solution to a second temperature of about 4° C. to about 30° C. wherein a cryoaggregate containing pathologic molecules and a third plasma solution is formed; and, filtering the third plasma solution to remove the pathologic molecules. In various embodiments, the pathological molecules are implicated in at least one of heart disease, micro-organism infection, viral infection, neurological disease, and autoimmune disease.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes to the claims that come within the meaning and range of equivalency of the claims are to be embraced within their scope. Further, all published documents, patents, and applications mentioned herein are hereby incorporated by reference, as if presented in their entirety.

### Examples

Thermofiltration and double filtration plasmapheresis (DFPP) were introduced for therapeutic apheresis. These three methods of plasma filtration are summarized in FIG. 2. Both the thermofiltration and DFPP utilize plasma fractionators in which the membrane has a pore size between 0.01-0.05 μm. The differences are that the former uses a temperature at 37-40° C. while the DFPP utilizes a temperature of 30-37° C. within the temperature ranges, not producing cryoaggregates inside the plasma. Cryofiltration utilizes a larger membrane pore size of 0.1-0.5 μm and removes the Cryogel at 0-4° C.

Recently, we have developed an improved method for augmenting the removal of pathological macro- and mini-molecules from plasma.

At a lower temperature (FIG. 2), the particle sizes of molecules in plasma are increased if heparinized plasma is exposed to a temperature below 30° centigrade (FIG. 3). In various embodiments, non-heparinized plasma is used. We have determined that a membrane with a pore size in the range of 0.01-0.1 μm will remove pathologic molecules more effectively than a membrane with a pore size of 0.1-0.5 μm. A pore size, one order of magnitude smaller than the plasma separator membrane, should provide a more effective apheresis effect. The reason is, by cooling heparinized plasma below 30° C., molecule sizes in plasma are enlarged in the form of cryoaggregates. Thus, plasma filtration at 30-4° C. is more effective in removing cryoaggregate molecules. At 37° C., peak molecule sizes in plasma are less than 0.01 μm. At 24° C., peak molecule sizes increase and are in the range of 0.01 μm. At 4° C., all plasma molecule sizes are between 0.01-0.1 μm. Therefore, utilizing a plasma fractionator with a pore size of 0.01-0.1 μm should be the most effective for cryoaggregate removal (FIG. 3). In conclusion, a plasma fractionator having a pore size of 0.1-0.01 μm is capable of functioning for the effective removal of pathologic molecules and thus can replace the cryofilter having a pore structure of 0.1-0.5 μm.

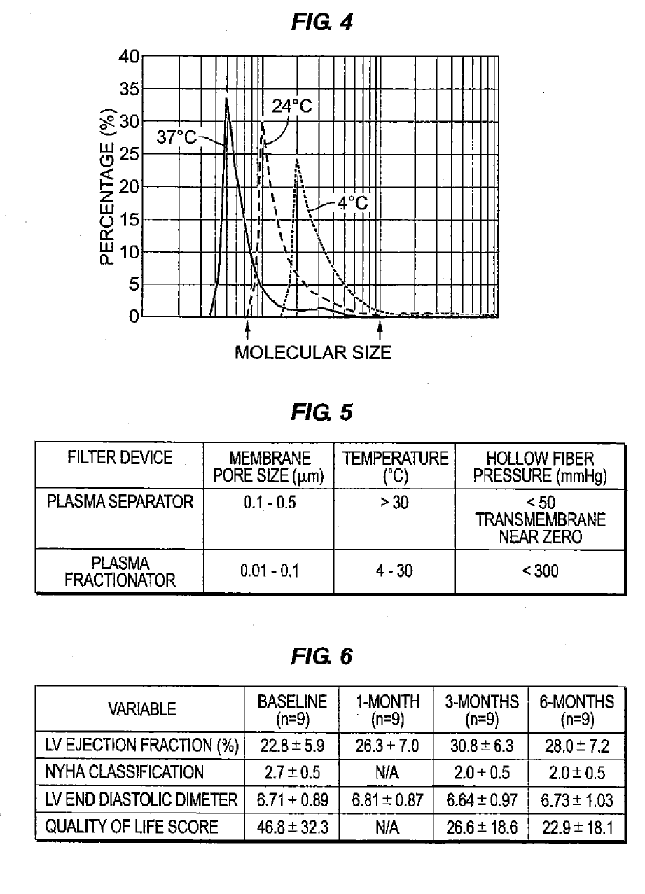

In an example, a patient's plasma (37° C.) was cooled below 30° C. The clear, transparent plasma (right) became a white, milky appearance (left); indicating the molecules in the plasma are altered by exposing it to the cold environment. This phenomenon occurred when plasma was cooled between 30-4° C. FIG. 4 illustrates that when the plasma is cooled from 37° C. to 24° C. and to 4° C., the particle sizes in the plasma become larger indicating the formation of cryoaggregates in plasma. Particle sizes in plasma were measured using NanoTrae (NPA250) provided by Nikkiso Pump America, Houston, Tex.

Thus as shown in FIG. 2, plasma fractionation at 4-30° C. with the filter having a membrane pore size of 0.01-0.1 μm should be more effective than current on-line plasma purification method. This plasma purification method can be applied for both, On-Line Pressure and Temperature Controlled Apheresis Therapy and for an Off-Line Automatic Plasma Purification for Exchange Transfusion.

In an embodiment, the filter specifications and operating conditions for a Pressure and Temperature Controlled Cryoaggregate Removal System for autologous plasma purification is summarized in FIG. 5. However, in various other embodiments, other specifications are capable of use.

### Plasma Exchange Clinical Study

A clinical study of the effects of conventional plasma exchange in nine patients with non-ischemic cardiomyopathy has been conducted by Dr. Torre-Amione at The Methodist Hospital, Houston, Tex. The patients were New York Heart Association (NYHA) Class II-IV with a left ventricular ejection fraction (LVEF) <30% documented by echocardiography and were receiving standard medical therapy for at least three months.

The nine patients underwent five plasma exchange procedures, by centrifugal plasmapheresis, over a 10-day period with replacement therapy consisting of intravenous infusion of 2 liters albumin and 1 liter saline solution containing 500 mg/kg 7-globulin. Echocardiographic and Quality of Life data were analyzed at baseline, and at 1-, 3- and 6-months after the plasma exchange procedure.

It was found that mean LVEF at baseline, 1-, 3- and 6-months was 22.8%, 26.3%, 30.8% and 28.0%, respectively (p=0.03 for baseline vs 3-months, FIG. 6). An improvement in NYHA functional class was also demonstrated (p=0.008), and quality of life score (FIG. 6).

The use of five (5) sessions of plasmapheresis over a 10-day period in patients with chronic heart failure due to non-ischemic cardiomyopathy was associated with a demonstrable improvement in LVEF, NYHA Classification, and Quality of Life Score. This data supports a potential biological role of immune mediators in the progression of heart failure and establishes the basis to conduct a larger clinical study utilizing plasmapheresis as a treatment strategy (presented at Heart Failure Society of America, 11th Annual Scientific Meeting 2007, “Plasmapheresis: A Potential New Strategy to Treat Chronic heart Failure due to Non-Ischemic Cardiomyopathy’).

### In-Vitro Plasma Purification Studies

Research on the effects of apheresis for treating heart failure is limited by the lack of a well-characterized, large animal model of dilated cardiomyopathy that can be treated with extracorporeal apheresis techniques. For the clinical plasma exchange studies described above, plasma was discarded after each treatment session. This gave our group at the Center for Artificial Organ Development at Baylor College of Medicine the opportunity to perform the following in-vitro studies on the harvested plasma from dilated cardiomyopathy patients.

### Harvesting Cell Free Plasma

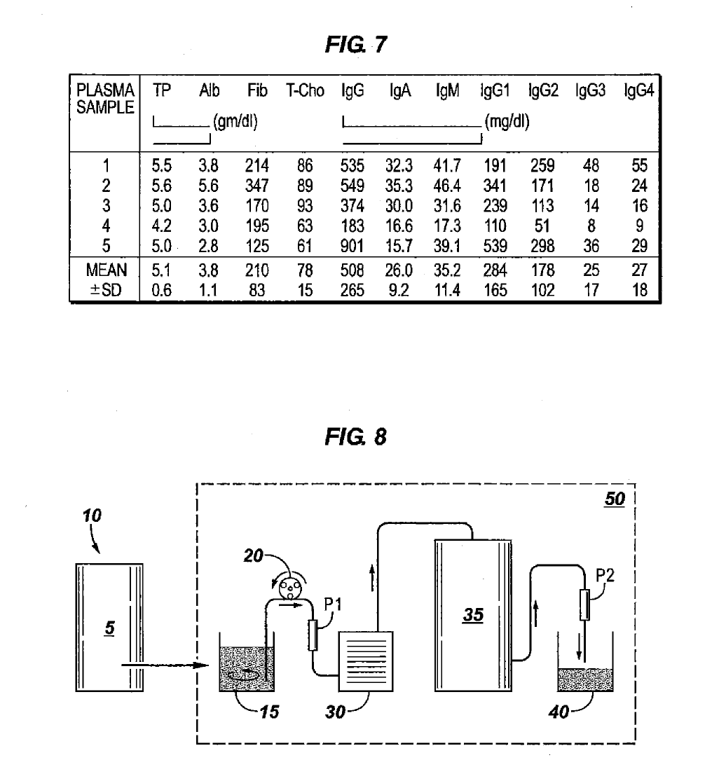

Harvested plasma from two non-ischemic cardiomyopathy patients undergoing plasma exchange was utilized for these studies. Plasma from five plasma exchange sessions (three liters each) was obtained from the two patients. Since this plasma was obtained using the centrifugal method, cellular components were removed, in-vitro, using a membrane plasma separator (Plasmaflo® OP-05W, Asahi Kasei Medical, Ltd., Tokyo, Japan). The plasma, without cellular elements, was subjected for a biochemical profile. Biochemical analysis included: total protein, albumin, fibrinogen, total cholesterol, IgG, IgA, IgM, IgGl-2-3 and -4, TNF-a, II-1B, II-6 and II-8. The baseline data are summarized in FIG. 7.

### In-Vitro Plasma Purification Process

The harvested plasma was heparinized with 1,000 units/L heparin. The heparinized plasma was cooled to 10° C. The cooled plasma was perfused through a plasma fractionator (Rheofilter™ SR-20, Asahi Kasei Medical, Ltd., Tokyo, Japan, having a pore size of 0.02 μm, within this Invention Disclosure framework of 0.01-0.1 gm) at a rate of 20 ml/min for removal of the large cryoaggregate molecules from the plasma (FIG. 4). For the first membrane plasma separation procedure, the operational temperature should be >30° C. and the TMP should be near zero mmHg. For the second membrane plasma fractionation procedure, the operational temperature should be <30° C. and the TMP should be <300 mmHg. When the transmembrane pressure differential increased to 300 mmHg, the plasma fractionation procedure was stopped. The cryoaggregate-removed plasma was subjected to the same biochemical profile described above, and compared with the baseline plasma values. This off-line in-vitro plasma purification system is called Off-LAPPET abbreviated from Off-Line Automatic Plasma Purification for Exchange Transfusion.

### Filters Used for In-Vitro Plasma Purification Process

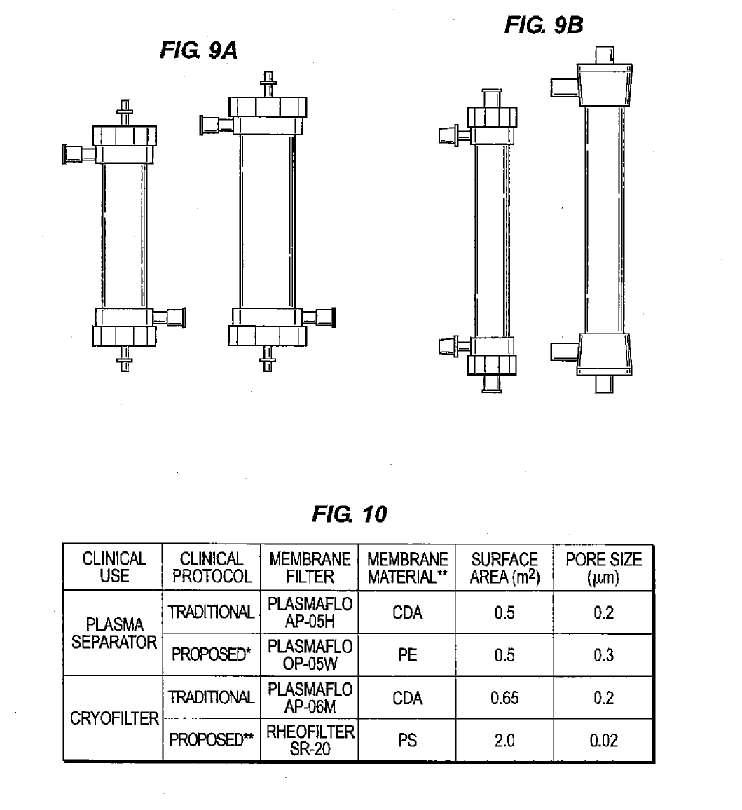

The original filters used for cyrofiltration (Nose Y, et al: Therapeutic Apheresis 4-1, 38-43, 2000) and the current filters used for cryoaggregate filtration (Plasmaflo OP-05W and Rheofilter SR-20) for the plasma purification procedure are shown in FIG. 9. In FIG. 9-A, traditionally used plasma separator (left) and cyrofiltration membrane (right) are shown. In FIG. 9-B, the new plasma separator (left) and new plasma fractionator (also called cryoaggregate filter, right) were used for the in-vitro plasma purification procedures. The specifications for filters used in the traditional cyrofiltration system and the filters used for the in-vitro plasma purification system are shown in FIG. 10.

FIG. 8 illustrates an embodiment of cryoaggregate removal, where plasma is cooled between 4-30° C. In FIG. 10, * indicates Better Biomaterial (CDA vs PE); Larger Pore Size (0.2 vs 0.3 pm). ** indicates Better Biomaterial (CDA vs PS); Larger Surface Area (2.0 vs 0.65 m2); Critical Pore Size (0.02 vs 0.2 μm). *** indicates CDA=Cellulose-di-acetate; PE=Polyethylene; PS=Polysulfone.

### Macromolecules Removed

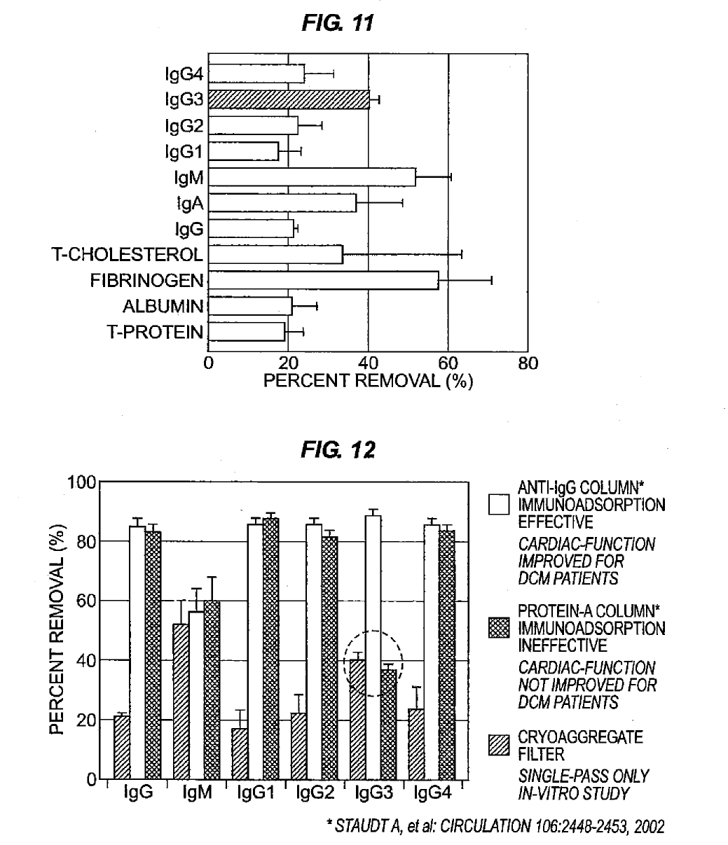

FIG. 11 illustrates the percent removal of macromolecules assayed. Fibrinogen, total cholesterol, Ig-M and IgG3 were removed effectively while 80% of albumin remained. Removal rates for immunoglobulin fractions by this plasma fractionation filter were compared with those of anti-IgG columns and protein-A columns Removal of IgG3 fraction by our method (=40% removal) was demonstrated while other IgG fractions did not decrease substantially (=20% range, FIG. 12). It has been reported that it is necessary to remove IgG3 more than 65% to demonstrate clinical efficacy. Therefore, recirculation filtration, instead of a single-pass method shown here, should be performed on harvested plasma.

Since the therapeutic effects of apheresis for treating non-ischemic cardiomyopathy are dependent on the selective removal of IgG3, the proposed plasma purification process for macromolecular removal will involve subjecting plasma to recirculation filtration. In addition, supplemental infusion of IgG may not be required since it is anticipated that approximately 30% of other IgG fractions are expected to be removed. Since the need for substitution fluids and agents are reduced, the proposed blood purification procedure should be performed in a cost effective manner.

### Removal of Proinflammatory Cytokines

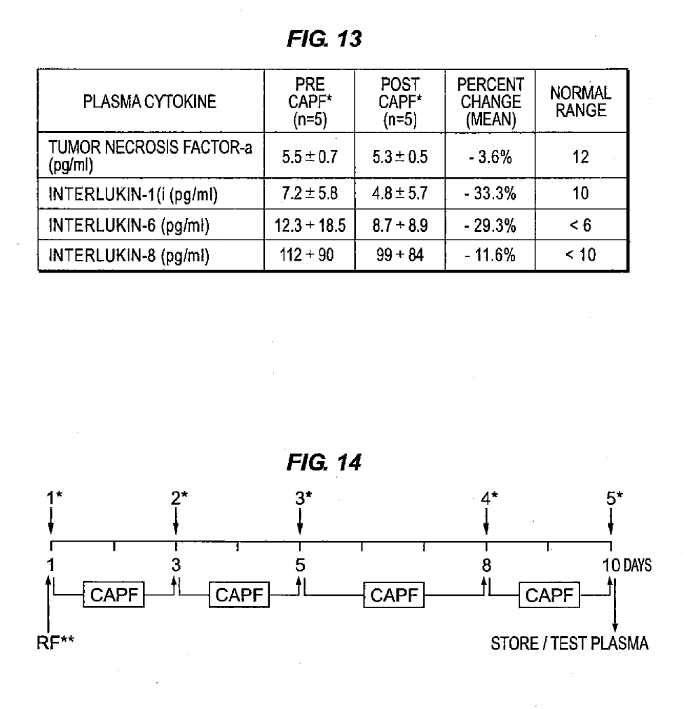

The removal rates of proinflammatory cytokines by our proposed plasma purification method (cryoaggregate filtration) are shown in FIG. 13. Reductions of these molecules are demonstrated when they are elevated above the normal range. To achieve the therapeutic effects in non-ischemic cardiomyopathy, reduction of these cytokine plasma levels may be necessary. Since we propose to conduct plasma recirculation filtration, adequate removal of proinflammatory cytokines is anticipated.

### Physiological Safety of Infusing Purified Plasma

A 90 kg swine was subjected to plasma separation and plasma purification with infusion of purified plasma for 200 minutes (3+ hrs). The animal was heparinized with 9,000 units IV initially and 5,400 units/hour during the procedure. The external jugular veins were cannulated for blood withdrawal and infusion, and extracorporeal circulation was established at 100 ml/min. Plasma separation and plasma purification was performed at the flow rate of 20 ml/min A total of 4 liters of the plasma was processed. During the 200 minutes of plasma filtration, blood pressure, SpO2 and heart rate remained unchanged. The procedure was well tolerated by the experimental animal.

### Example of Proposed Plasma Exchange Off-Line System

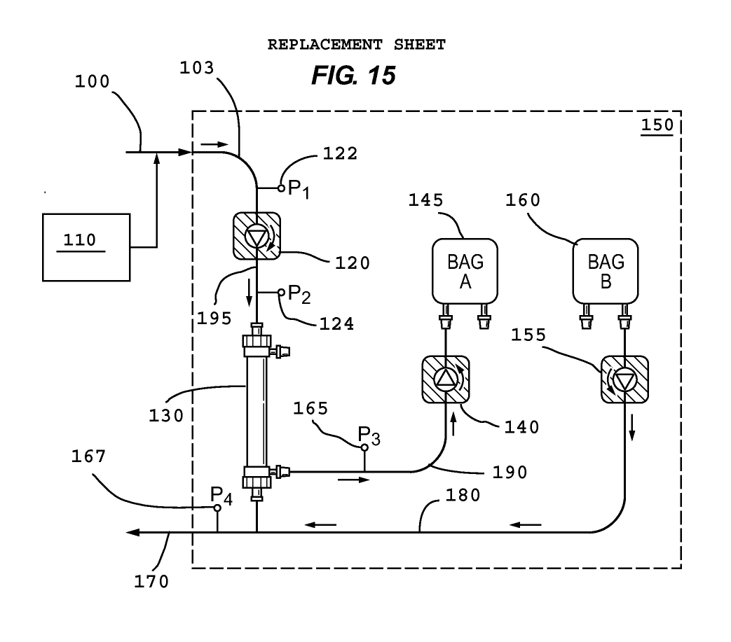

An embodiment of a proposed plasma exchange system and procedure according to an embodiment of the present invention is illustrated in FIG. 15. Plasma exchange system 150 generally comprises a patient 100 (not shown) or other source of fluid containing plasma, a heparin infusion pump 110, a first blood pump 120, a plasma filter 130, a second blood pump 140, a third blood pump 155, a harvested plasma bag 145 or storage container, and a purified plasma bag 160 or storage container. In various embodiments, the aforementioned components are connected via tubing or pipes, such as tube 103, tube 195, tube 190, and tube 180. Multiple pressure and/or temperature readings are capable of being taken at various locations along the tubes. In an embodiment, there is a pressure instrument at site 122, a second pressure instrument at site 124, a third pressure instrument at site 165, and a fourth pressure instrument at site 167.

Equipment available for use in various embodiments of the present invention can be widely varied. Specific examples mentioned herein are not to be construed as limiting, as would be understood by one of ordinary skill in the art. For example, in general, any blood pump can be used. Examples of blood pumps include systolic pumps, a reciprocating pump, double-action pump, suction pump, piston pump, kinetic pump, and/or the like. In various embodiments, blood may be removed from a patient at a rate of up to 100 ml/min. However, any rate acceptable in the art field can be used with various embodiments of the present invention.

As such, in an embodiment, a first blood pump 120 withdraws blood from patient 100 (not shown) through tube 103. Pressure instrument 122 may be coupled to first blood pump 120 such that the rate of first blood pump 120 can be controlled by the pressure in tube 103 and/or pressure in tube 195. If needed, heparin can be infused to the withdrawn blood from heparin pump 110. The withdrawn blood is then conveyed along tube 195 across pressure instrument 124 and into plasma filter 130 where plasma is filtered form the other constituents of the patient's blood.

In various embodiments, the pressure entering plasma filter 130 is such that it will not clog the filter. In an embodiment, the pressure entering plasma filter 130 is from 1 mmHg to 100 mmHg. In an alternate embodiment, the pressure is from 5 mmHg to 75 mmHg. In an alternate embodiment, the pressure is from 25 mmHg to 50 mmHg. In general, any pressure can be used as long as the pores of the plasma filter will not clog, such that effective plasma separation may occur.

As well, various plasma filters are capable of use in embodiments of a plasma exchange procedure as herein disclosed. In an embodiment, the plasma filter is a capillary membrane filter. In general, a pore size of 0.01 μm-2.0 μm can be used with the plasma filter. In an alternate embodiment, the pore size of the plasma filter is 0.05 μm-1.0 μm. In an alternate embodiment, the pore size of the plasma filter is 0.1 μm-0.5 μm. In general, any pore size can be used.

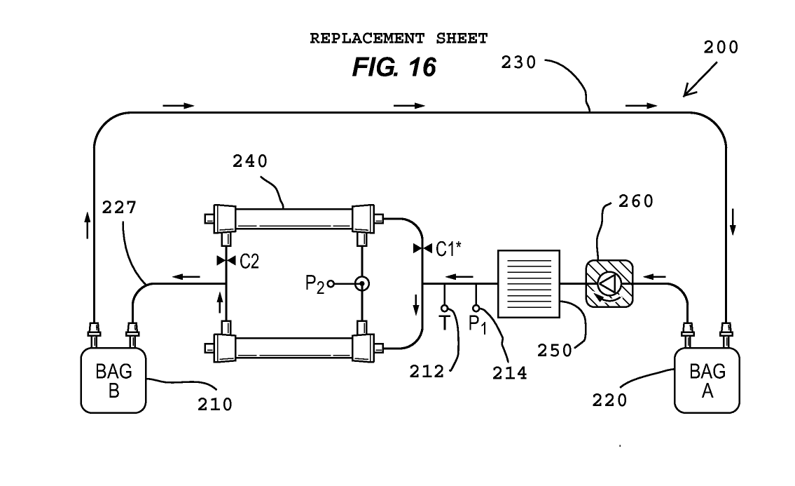

The fractionated or separated plasma solution is then conveyed along tube 190 to a harvested plasma bag 145. A second blood pump 140 can be used to pump the plasma solution into a harvested plasma bag 145, if needed or desired. Harvested plasma bag 145 is then taken off-line for further processing, such as for cryoaggregate filtration, as is disclosed in FIG. 16.

A purified plasma bag 160 is connected to system 150 for re-infusion to patient 100. A purified plasma stream is pumped from purified plasma bag 160 by the third blood pump 155 back to patient 100 where it can be infused.

Now referring to FIG. 16, system 200 illustrates a cryoaggregate filtration system 200. In general, the harvested plasma bag 145 is removed from system 150 and connected to tube 220 and tube 230. Cryoaggregate pump 260 pumps the plasma solution across a cooling unit 250 wherein the temperature of the plasma solution is reduced to about 4° C. to about 30° C., wherein the formation of a cryoaggregate commences. The cooled plasma solution is then fed to at least one filter 240 wherein the cryoaggregate is separated. Tube 227 conveys a purified plasma solution from filter 240 to the purified plasma bag 210.

In various embodiments, the plasma solution is circulated through tube 230 back to the harvested plasma bag 220 for further processing.

### Protocol and Procedures

A proposed plasma exchange protocol with re-infusion of autologous purified plasma is shown in FIG. 14. In an embodiment, five (5) plasma exchange treatment sessions will be performed over a 10-day period. However, any number of procedures can be done, in various embodiments. For the first plasma exchange session, conventional replacement fluids (2 liters albumin+1 liter saline) will be infused. Three liters of harvested plasma will be purified by cryoaggregate filtration (recirculation method), stored and be re-infused during the next plasma exchange treatment session. For the 2nd, 3rd, 4th and 5th plasma exchange sessions, 3 liters per session of cryoaggregate filtered plasma will be re-infused. CAPF is Cryoaggregate Plasma Filtration. In this experiment, RF equals replacement fluid of 2 liters of albumin and 1 liter of saline (+/−500 mg/kg γ-globulin).

Proposed Plasma Exchange Protocol with Re-Infusion of Autologous Purified Plasma

The proposed plasma exchange procedure is shown in FIG. 15. The membrane plasma separator (Plasmaflo® Hollow Fiber Membrane, OP-05W, manufactured by Asahi Kasei Medical Co., Ltd., Tokyo, Japan) has been widely used clinically in Japan and been proven to be an effective device. Prior to starting extra-corporeal circulation the patient will be heparinized (100 units/kg). Heparin will be infused continuously during the procedure at a rate of 50 units/kg/hour. Plasma will be harvested at the rate of 15-20 ml/min.

### On-Line System

Conversion of the previously disclosed off-line system to an on-line system is straightforward, only requiring that the harvested plasma bag 145 and purified plasma bag 160 elements are replaced with a cooling unit and cryoaggregate filter, as would be understood by one of ordinary skill in the art.

### Proposed In-Vitro Plasma Purification Procedure (Off-LAPPET)

### In-Vitro Cryoaggregate Filtration Procedure

Plasma will be harvested in 750 ml bags. It will be removed from the plasma exchange circuit and subjected to cryoaggregate filtration at the rate of 20 ml/min by cooling the plasma to 10° C. (FIG. 16). The membrane plasma fractionator or cryoaggregate filter (Rheofilter™ Hollow Fiber Plasma Component Separator, SR-20) is manufactured by Asahi.Kasei Medical Co., Ltd., Tokyo, Japan. Two cryoaggregate filters will be connected in a parallel circuit with one filter used at a time. The hollow fiber membranes of the filters become clogged with cryoaggregate material after approximately 2 liters of plasma is processed. Thus, when the transmembrane pressure differential (P1-P2) reaches 300 mmHg, the filters will be switched by clamping the appropriate inlet and outlet tubing (FIG. 10). Harvested plasma will be recirculated in order to achieve the target plasma IgG3 removal levels of 65%. The purified plasma, with cryoaggregate factors removed, will be re-infused to the patient via the plasma exchange system. Approximately 3 liters of plasma will be harvested, processed and re-infused during the next plasma exchange treatment session.

### Comparative Performance of SR-20 Filter (Port Size of 0.02 um) and Original Cryofilter (Pore Size of 0.2 um)

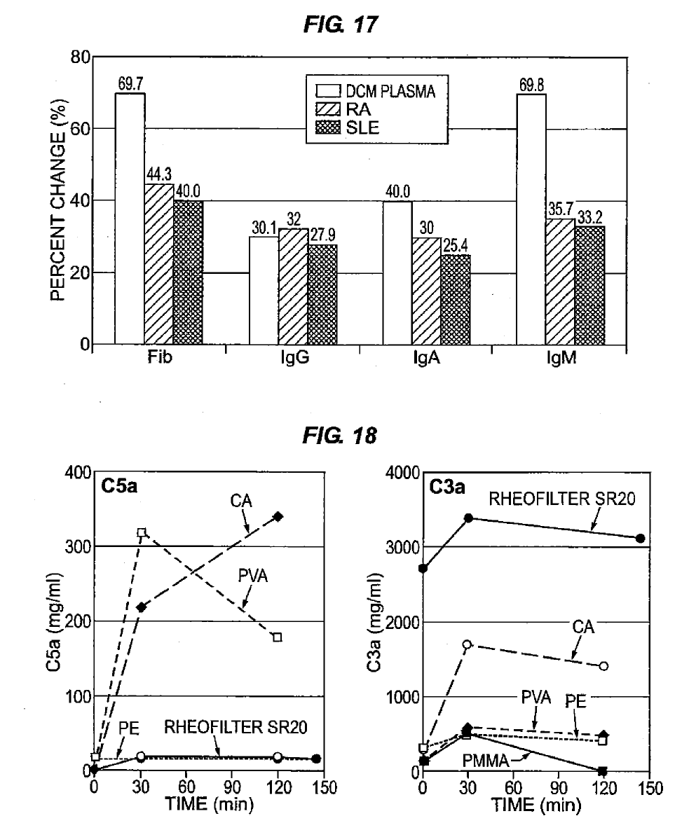

Compared to the original cyrofiltration system (FIG. 9-A, FIG. 13), removal of fibrinogen, IgA and IgM is higher with the new Off-LAPPET system (FIG. 9-B, FIG. 13), while the removal of IgG was comparable (FIG. 17).

Comparative removal rates of fibrinogen and Ig fractions by SR-20 and original cryofilter (DCM plasma=SR-20 filter; RA and SLE=original cryofilter) ‘Apheresis Manual’, Japanese Association for Apheresis 1999, p. 41 (Japanese text by Dr. Akio Kawamura)

### Comparative Studies of Compliment Activation (C5a and C3a) for SR-20 and Other Filters

Compliment activation of C5a and C3a is also reduced for the new Rheofilter™-SR-20 cryoaggregate filtration system (FIG. 12). C3a activation between the inlet and outlet of the filter is shown in FIG. 13. There was almost no increase in outlet C3a compared with the inlet C3a level for the SR-20 filters (data other than for the SR-20 from Nose Y: Therapeutic Apheresis 6:333-347, 2002). The proposed in-vitro cryoaggregate filtration procedure, or Off-LAPPET, should be equally or more effective and biocompatible compared with cyrofiltration procedures performed with the original plasma fractionation filters.

### Cryoaggregate Filtration and Clinical Application

### Heart Diseases

### Non-Ischemic Cardiomyopathy

Conventional plasma exchange for non-ischemic cardiomyopathic patients has been shown to be effective (Section 2.0). Cryoaggregate filtration adequately removes pathologic molecules including IgG3 and cytokines from the patient's plasma and should be more cost effective than standard plasma exchange. In addition, the cryoaggregate filtration method may be repeated as the patients' clinical condition dictates.

### Ischemic Cardiomyopathy

Cryoaggregate filtration effectively removes atherosclerosis-inducing pathologic molecules including low density lipoprotein, fibrinogen, and auto-antibodies. Thus, the therapy may be expected to be beneficial for this patient population.

### Other Metabolic and Autoimmune Diseases

There are many metabolic and autoimmune diseases currently treated by plasma exchange, cyrofiltration or DFPP. These disease populations should also benefit from the cryoaggregate filtration method (Blood Purification, Past, Present and Future, The ICMT publication on Artificial Organs, Y Nose, H Kambic and S Ichikawa ICMT Press Cleveland, Ohio, 2001, Page 188).

Compared to the conventional albumin-saline replacement fluids for plasma exchange, autologous plasma purification with removal of cryoaggregate factors should be physiologically acceptable and clinically safe and effective. Cryoaggregate filtered purified plasma contains sufficient levels of albumin and γ globulin fraction, therefore eliminating the need for expensive substitution fluids or supplemental macro-molecules and making the plasma exchange procedure more cost effective.

As indicated above, cryoaggregate filtration is applicable for both off-line plasma purification (Off-LAPPET) and on-line plasma purification (PATCAT).

### REFERENCES

¹ Nosé, Y. Therapeutic Membrane Plasmapheresis, In T. Oda Ed. Therapeutic Plasmapheresis, 1981, FK Shcattauer Verlag, Stuttgart, Germany.
² Nosé, Y. Congress presidential address: 5th WAA Congress, Therapeutic Artificial Organs 10 years after, Artificial Organs 19(3) 204-210, 1995.
³ NoséY, Kambic H. E. and Ichikawa. Blood purification-artificial kidney and plasmapheresis-past, present and future, ICAOT/ICMT Press Houston, Tex. 2001.
⁴ Muller J, Wallukat G, Dandel M, et al: Immunoglobulin adsorption in patients with idiopathic dilated cardiomyopathy. Circulation 101:385-391, 2000.
⁵ Felix S B, Staudt A, Dorffel, et al: Hemodynamic effects of immunoadsorption and subsequent immunoglobulin substitution in dilated cardiomyopathy. J Amer Col Cardiol 35:1590-1598, 2000.
⁶ Staudt A, Dorr M, Felix S B, et al: Role of immunoglobulin G3 subclass in dilated cardiomyopathy: Results from Protein A immunoadsorption. Amer Heart J 150:729-736, 2005.
⁷ Staudt A, Hummel A, Felix S B, et al: Immunoadsoprtion in dilated cardiomyopathy: 6-month results from a randomized study. Amer Heart J 152:712.e1-6, 2006111.
⁸ Cooper L t, Belohlavek M, Winters J L, et al: A pilot study to assess the use of Protein A immunoadsoprtion for chronic dilated cardiomyopathy. J Clin Apheresis 22:210-214, 2007.
⁹ Burgstaler E, Cooper L T and Winters J L: Treatment of chronic dilated cardiomyopathy with using the staphylococcal A-Agarose column: A comparison of immunoglobulin reduction using two different techniques. J Clin Apheresis 22:224-232, 2007.
¹⁰ Hessel F P, Wegner C, Muller J, et al: Economic evaluation and survival analysis of immunoglobulin adsorption in patients with idiopathic dilated cardiomyopathy. Eur J Health Economics 5:58-63, 2004.
¹¹ Koll, R A, Klinkmann. J, and Richter RheoSorb: A specific adsorber for fibrinogen Elimination in clinical situation with impaired Rheeology. Artif Organs 26(2):145-151, 2002.
¹² Koga, N. The retardation of progression, stabilization and regression of coronary and carotid atherosclerosis by familial hypercholesterolemic. Therapeutic Apheresis 1(3):260-270, 1997.

What is claimed is:

1. A process for the purification of a first plasma solution taken from a patient, said process comprising the steps of:
fractionating said first plasma solution to form a second plasma solution, wherein said first plasma solution is at a first temperature sufficiently high to avoid formation of a cryoaggregate;
cooling said second plasma solution to a second temperature to form a third plasma solution, wherein a cryoaggregate is formed in said third plasma solution, and wherein said second plasma solution is at a second temperature sufficiently high to avoid formation of a cryogel; and
filtering said third plasma solution to remove said cryoaggregate.

2. The process of claim 1, wherein at least one of said step of fractionating or filtering utilizes a membrane filter.

3. The process of claim 1, wherein said first temperature is greater than or equal to about 30° C.

4. The process of claim 1, wherein said second temperature is about 4° C. to about 30° C.

5. The process of claim 2, wherein said membrane filter has a pore size of about 0.1 μm to about 0.5 μm.

6. The process of claim 1, wherein the process is off-line.

7. The process of claim 1, wherein the process is on-line.

8. A system for the purification of a plasma solution withdrawn from a patient comprising the following components operatively connected:
said patient;
a pump;
a plasma fractionator filter; and
a cryoaggregate filter system comprising a cooling unit and a filter.

9. The system of claim 8, wherein the system is an off-line system.

10. A process for removing pathologic molecules from a first plasma solution, said process comprising the steps of:
filtering said first plasma solution to form a second plasma solution, wherein said first plasma solution is at a first temperature of greater than about 30° C.;
cooling said second plasma solution to a second temperature of about 4° C. to about 30° C. to form a third plasma solution, wherein a cryoaggregate containing pathologic molecules is formed in said third plasma solution; and
filtering said third plasma solution to remove said pathologic molecules.

11. The process of claim 10, wherein the pathological molecules are implicated in at least one of heart disease, micro-organism infection, viral infection, neurological disease, and autoimmune disease.

12. The system of claim 8, wherein the system is an on-line system.
